(19) United States
(12) Patent Application Publication
(10) Pub. No.: US 2026/0268719 A1
(43) Pub. Date: Sep. 10, 2026

(54) SYSTEM FOR PROVIDING VOTING SERVICE AND METHOD THEREOF

(71) Applicant: CJ ENM CO., LTD., Seoul (KR)

(72) Inventors: Geun Ho HA, Seoul (KR); Young Ju OK, Seoul (KR); Dong Hoon HONG, Seoul (KR); Ji Hee YANG, Seoul (KR); Su Min JUNG, Seoul (KR)

(21) Appl. No.: 19/167,876

(22) PCT Filed: Mar. 22, 2024
(86) PCT No.: PCT/KR2024/003618

§ 371 Date: Sep. 23, 2025

(30) Foreign Application Priority Data
Apr. 4, 2023 (KR) 10-2023-0044389
Jul. 20, 2023 (KR) 10-2023-0094566

(51) Int. Cl. G07C 13/00; G06F 3/04842; G06F 8/61; H04L 9/32; H04L 9/40

(52) U.S. Cl. CPC G07C 13/00; G06F 3/04842; G06F 8/61; H04L 9/3247; H04L 63/123

(57) ABSTRACT

Provided is a system for providing a voting service and a method thereof. According to an example embodiment, the method of providing a voting service through a user terminal includes receiving a request related to a page from a user, processing, when the request is a request related to a first type page, the request related to the first type page (a page provided while a voting service category is active) by communicating with a content delivery network (CDN), and processing, when the request is a request related to a second type page, the request related to the second type page (a page other than the first type page) by communicating with a database server.

### TECHNICAL FIELD

The present disclosure relates to a method of providing a robust and reliable voting service and a system performing the same.

### BACKGROUND ART

As the Korean Wave contents, including K-pop, continues to gain global popularity, there have been increasing efforts to move away from the traditional model where all content is planned solely by agencies and presented to the public in a one-sided manner.

One of the most notable changes is in how K-pop group members are selected. While traditionally entertainment agencies held private auditions to scout members and debuted them after a period of in-house training, a growing trend involves K-pop group members being chosen through public auditions where the viewers vote, and then theses viewer-chosen members debut immediately as a group, continuing their careers with strong public support and media attention. Since groups that debut in this manner may reduce risks associated with group formation as a fanbase is established even before the official debut, there has been a growing trend of forming groups based on viewer voting results.

However, as viewer voting is conducted via web pages or mobile applications provided by entertainment agencies, and given the potential for sudden traffic spikes due to the nature of voting, a system architecture capable of managing such a case is required. Furthermore, a measure to improve the fairness and reliability of the voting system is required to deter attempts at manipulation by excessively devoted fans using unauthorized methods.

### DETAILED DESCRIPTION OF THE INVENTION

### Technical Goals

It is an object of the present disclosure to efficiently manage large-scale traffic that may occur during voting.

It is also an object of the present disclosure to effectively prevent an act of abuse that may occur during voting.

It is yet another object of the present disclosure to verify integrity of voting data collected.

Technical objects to be achieved by the present disclosure are not limited to the technical objects described above, and other technical objects may be inferred from the following example embodiments.

### Technical solutions

A method of providing a voting service through a user terminal includes receiving a request related to a page from a user, processing, when the request is a request related to a first type page—the first type page is a page provided while a voting service category is active—, the request related to the first type page by communicating with a content delivery network (CDN), and processing, when the request is a request related to a second type page-the second type page is a page other than the first type page-, the request related to the second type page by communicating with a database server.

More specifically, the processing of the request related to the first type page includes processing a display request for the first type page, and the processing of the display request for the first type page may include transmitting the display request to the CDN, receiving page information including a hypertext markup language (HTML) file that is not prepared for rendering from any CDN server included in the CDN, and displaying the first type page on a screen of the user terminal based on the page information.

Meanwhile, more specifically, the processing of the request related to the second type page includes processing a display request for the second type page, and the processing of the display request for the second type page may include transmitting the display request to the database server, receiving page information including an HTML file that is prepared for rendering from the database server, and displaying the second type page on a screen of the user terminal based on the page information.

Meanwhile, the first type page may include a selection page from which at least one of a plurality of options is selectable, and a voting complete page that displays voting results after submitting voting information based on the option selected from the selection page.

According to an example embodiment, from the selection page, an image for each of the plurality of options and a frame object corresponding to a selectable number of options may be displayed, and an image of an option selected from the plurality of options may be displayed within the frame object.

According to another example embodiment, from the selection page, a name for each of the plurality of options may be displayed, and the plurality of options may be arranged and displayed based on the name.

According to another example embodiment, the first type page may further include a post-selection page that requests a user to confirm whether to submit the voting information or that notifies whether the voting information is eligible for submission, prior to submission of the voting information. The post-selection page may display a submit button for submitting the voting information, and upon selection of the submit button, a selected option, a human interaction proof (HIP) interface, and a confirmation button may be displayed, a video advertisement may be played automatically upon selection of the confirmation button after passing HIP, and when the video advertisement is finished playing, the page may be switched to the voting complete page.

A method of providing a voting service through a server system including a content delivery network (CDN) server and a database server includes receiving requests related to a first type page from a plurality of user terminals, selecting at least a portion of the requests based on an order in which the requests are received, and processing the selected requests by allocating a resource to the selected requests. The selecting includes newly selecting at least a portion of requests remaining after excluding the selected requests based on an order in which the requests are received every time each of the selected requests is processed.

According to an example embodiment, the method may further include transmitting a standby request to each user terminal that has transmitted the requests remaining after excluding the selected requests while the selected requests are being processed.

Meanwhile, according to an example embodiment, in processing a submission request for voting information through the first type page, the processing may include determining whether to authorize each of the selected requests, collecting voting information corresponding to an authorized request among the selected requests, and blocking an unauthorized request among the selected requests.

For example, the determining of whether to authorize each of the selected requests may include determining, a request transmitted more than a predetermined number of times from a user terminal to which an identical internet protocol (IP) address is assigned, a request transmitted for more than once through a browser with identical browser identification information, or a request transmitted through a browser corresponding to predetermined browser identification information, as an unauthorized request.

For example, the determining of whether to authorize each of the selected requests may include identifying a combination of signature information for authenticating a voting service application installed on each of user terminals that transmitted the selected requests, and unique identification information of each of the user terminals, and determining a request transmitted from a user terminal of which the combination is identified more than once as an unauthorized request.

For example, the determining of whether to authorize each of the selected requests may include determining, based on a package name and an installation directory of a voting service application installed on each of user terminals that transmitted the selected requests, whether a clone application of the voting service application is installed on each of the user terminals, and determining a request transmitted from a user terminal determined to have the clone application installed as an unauthorized request.

For example, the determining of whether to authorize each of the selected requests may include determining, based on chipset information of a central processing unit (CPU) of each of user terminals that transmitted the selected requests, whether an emulator for a voting service application is installed on each of the user terminals, and determining a request transmitted from a user terminal determined to have the emulator installed as an unauthorized request.

Meanwhile, according to an example embodiment, the method may further include storing the collected voting information in a database as voting raw data according to a predetermined schema, receiving a post-verification instruction from an administrator authorized using signature information, determining validity of each piece of the collected voting information based on the voting raw data according to the post-verification instruction, and determining voting information determined to be valid as final valid voting information.

Accordingly, the determining of the validity of each piece of the collected voting information may include identifying, among pieces of the voting raw data, voting raw data in which an email address included in the voting raw data is a temporary address and determining voting information corresponding to the identified voting raw data as invalid voting information.

Meanwhile, according to an example embodiment, the method may further include storing the collected voting information in a database as voting raw data according to a predetermined schema, authorizing an external server, that is authorized to verify data and had passed a predetermined signature information-based authentication process, to access the voting raw data, and receiving a verification result confirming integrity of the voting raw data from the external server. Additionally, the method may also include transmitting a signal indicating that the voting raw data is verified data to any user terminal using the voting service.

According to an example embodiment disclosed, a user terminal providing a voting service includes at least one processor, and a memory configured to store at least one instruction executable by the at least one processor, and the at least one processor is configured to, upon execution of the at least one instruction, receive a request related to a page from a user, process, when the request is related to a first type page-the first type page is a page provided while a voting service category is active-, the request related to the first type page by communicating with a content delivery network (CDN), and process, when the request is related to a second type page-the second type page is a page other than the first type page-, the request related to the second type page by communicating with a database server.

According to an example embodiment disclosed, a server system including a content delivery network (CDN) server and a database server includes at least one processor, and a memory configured to store at least one instruction executable by the at least on processor, and the at least one processor is configured to, upon executing the at least one instruction, receive requests related to a first type page-the first type page is a page provided while a voting service category is active-from a plurality of user terminals, select at least a portion of the requests based on an order in which the requests are received, and process the selected requests by allocating a resource to the selected requests. Here, the at least one processor, in selecting at least a portion of the requests, is configured to newly select at least a portion of requests remaining after excluding the selected requests based on an order in which the requests are received every time each of the selected requests is processed.

Detailed descriptions of other example embodiments are included in the detailed description and drawings.

### Effects of the Invention

According to the example embodiments, it is possible to efficiently manage large-scale traffic that may occur during voting by separating servers for processing related requests based on page type, thereby dispersing traffic.

According to the example embodiments, it is possible to improve fairness and reliability of voting by identifying an act determined to be an abuse among requests related to the voting based on detailed criteria.

According to the example embodiments, it is still possible to prevent manipulability and improve fairness and reliability of voting by re-verifying collected voting data through a verified third party.

Effects of the present disclosure are not limited to those described above, and other effects may be made apparent to those skilled in the art from the following description.

### BRIEF DESCRIPTION OF DRAWINGS

FIG. 1 is a schematic block diagram illustrating an environment in which a voting service is provided.

FIG. 2 is a flowchart illustrating a method of providing a voting service through a user terminal.

FIG. 3 is a flowchart for describing a method of processing a display request for a first type page and a second type page in greater detail.

FIGS. 4A, 4B, 4C, 4D, 4E, 4F, and 4G are illustrative diagrams of a voting service screen provided through a user terminal.

FIG. 5 is a flowchart illustrating a method of providing a voting service through a server system.

FIG. 6 is a flowchart for describing operation S530 in greater detail.

FIGS. 7 to 10 are illustrative diagrams related to an example embodiment for sorting out an abuse among user requests.

FIG. 11 is a flowchart of an example embodiment for post-verifying collected voting information.

FIG. 12 is a flowchart of an example embodiment for verifying collected voting information by an external server.

### MODE FOR CARRYING OUT THE INVENTION

Terms used in the example embodiments are selected, as much as possible, from general terms that are widely used at present while taking into consideration the functions obtained in accordance with the present disclosure, but these terms may be replaced by other terms based on intentions of those skilled in the art, customs, emergence of new technologies, or the like. Also, in a particular case, terms that are arbitrarily selected by the applicant of the present disclosure may be used. In this case, the meanings of these terms may be described in corresponding description parts of the present disclosure. Accordingly, it should be noted that the terms used herein should be construed based on practical meanings thereof and the whole content of this specification rather than being simply construed based on names of the terms.

In the entire specification, when an element is referred to as “comprising” or “including” another element, the element should not be understood as excluding other elements so long as there is no special conflicting description, and the element may include at least one other element. In addition, the terms “unit” and “module”, for example, may refer to a component that exerts at least one function or operation, may be realized in hardware, in software, or in a combination of hardware and software, and may not be clearly distinguishable when performing a predetermined operation, unlike what is described as an example.

Throughout the specification, the expression “at least one of a, b, and c” may include ‘a only’, ‘b only’, ‘c only’, ‘a and b’, ‘a and c’, ‘b and c’, or ‘all of a, b, and c’.

The terms “terminal” or “user terminal” as used herein may be embodied as a computer or a portable device capable of accessing a server or another terminal through a network. Here, the computer may include, for example, a notebook computer, a desktop computer, and a laptop equipped with a web browser, and the portable device, as a wireless communication device that guarantees portability and mobility, may include all kinds of handheld wireless communication devices such as a communication-based terminal, a smartphone, and tablet PC, supporting international mobile telecommunication (IMT), code division multiple access (CDMA), w-code division multiple access (W-CDMA), long-term evolution (LTE), and the like.

According to descriptions below, terms such as “sending”, “communication”, “transmission”, and “reception”, of a signal or a message and other similar terms may indicate not only direct delivery of a signal, a message or information from one element to another element but also delivery via an intermediate element.

In particular, “sending” or “transmitting” a signal, message, or information to an element means indicating a final destination of signal, message, or information, and does not mean a direct destination. The same is true for “reception” of a signal, message or information. In addition, in the present disclosure, when more than two pieces of data or information are said to be “related”, it means that when one piece of data (or information) is obtained, at least a part of other data (or information) may be obtained based on it.

In addition, terms such as first and second may be used to describe various elements, however, the above elements shall not be limited to the above terms. The above terms may be used to distinguish one element from another.

For example, a first element may be named as a second element within the scope of the present disclosure, and similarly, a second element may also be named as a first element.

In the following description, example embodiments of the present disclosure will be described in detail with reference to the drawings to enable those skilled in the art to readily carry out the embodiments. The present disclosure may be applied in many different forms and is not limited to the embodiments described herein.

Hereinafter, example embodiments of the present disclosure will be described with reference to the drawings.

In describing the example embodiments, a description of contents well-known in the art to which the disclosure pertains and not directly relevant to the disclosure will be omitted. This is to make clearer description of core aspects of the present disclosure by omitting unnecessary descriptions.

Similarly, one or more elements of accompanying drawings may be exaggeratively or schematically illustrated for the same reason. Additionally, the dimensions of each element are not necessarily drawn to scale. The same reference numeral has been assigned to elements that are identical or corresponding to one another in each drawing.

The benefits and characteristics of the present disclosure, along with their method of achievement, will become clear through detailed reference to the example embodiments described in detail below in accordance with the accompanying drawings. However, the present disclosure is not limited to the example embodiments described below but may be implemented in various forms, the example embodiments are provided solely to complete the present disclosure and inform the scope of the present disclosure to those skilled in the art, and the present disclosure is only defined by the scope of the claims. Throughout the specification, like reference numerals will be referred to like elements.

In the present disclosure, it will be understood that each block of flowcharts and combinations of the flowcharts may be executed by computer program instructions. These computer program instructions may be loaded to a processor of a general-purpose computer, a special-purpose computer, or other programmable data processing equipment, so that the instructions executed by the processor of the computer or other programmable data processing equipment create means for executing functions specified in the flowchart block(s). These computer program instructions may also be stored in computer-usable or computer-readable memory that may direct a computer or other programmable data processing equipment to function in a particular manner, such that the instructions stored in the computer-usable or computer-readable memory produce an article of manufacture including an instruction mean that implement the function specified in the flowchart block(s). The computer program instructions may also be loaded into a computer or other programmable data processing equipment to cause a series of operational steps to be performed on the computer or other programmable equipment to produce a computer-executed process, so that the instructions performing the computer or other programmable apparatus provide steps for executing the functions described in the flowchart block(s).

Furthermore, each block may represent a portion of a module, a segment, or code, which includes one or more executable instructions for implementing a specified logical function(s). It should also be noted that in some alternative implementations, the functions noted in the blocks may occur out of order. For example, two blocks shown in succession may in fact be executed substantially concurrently, or the blocks may sometimes be executed in the reverse order, depending upon the functionality involved.

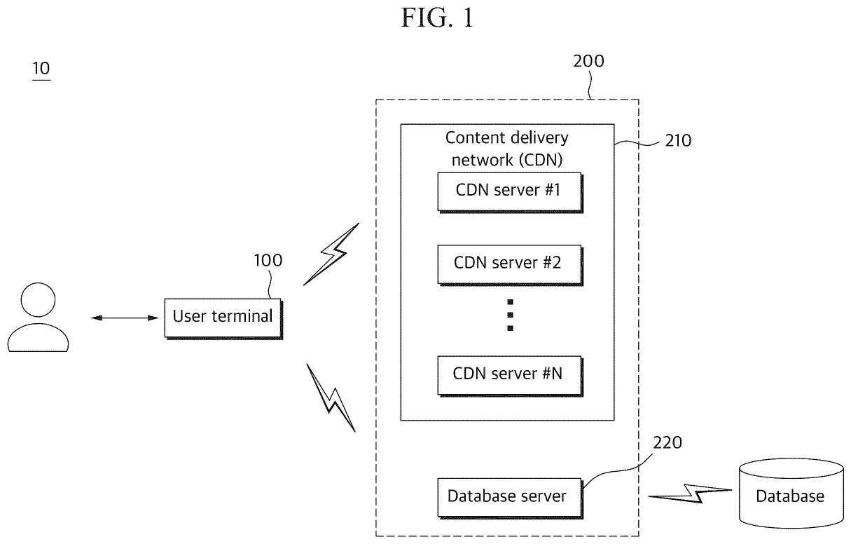

FIG. 1 is a schematic block diagram illustrating an environment in which a voting service is provided.

A user terminal 100 may receive an input from a user through an input device (e.g., a keyboard, a touch panel, and a microphone) or provide information to a user through an output device (e.g., a speaker, and a display screen). In addition, the user terminal 100 may communicate with a server system 200 through a connected network, or communicate with another external device. In the present disclosure, the user terminal 100 may collectively refer to a personal computer (PC), a tablet, and a smartphone, and its classification may be based on a way a user accesses the voting service. For example, when a user accesses to a website to check notifications related to voting or TV program information related to voting, a PC may function as the user device 100, and when a user launches a voting service application to cast a vote, a smartphone may function as the user terminal 100.

Although the FIG. 1 illustrates only one user terminal 100, this is for explanatory convenience only and a plurality of user terminals may communicate with the server system 200 simultaneously or sequentially according to example embodiments of the present disclosure. Therefore, the ‘user terminal 100’ as used herein may be understood as representing any user terminal that uses a voting service, and not as indicating a specific terminal communicating with the server system 200.

The server system 200 may collectively refer to servers communicating with each user terminal to provide a voting service to a number of users, and, in the present disclosure, the server system 200 may also refer to a system including a content delivery network (CDN) server and a database server. That is, an additional server other than the CDN server or the database server may be included in the server system 200, and, in the present disclosure, when the user terminal 100 and the server system 200 are said to be communicating with one another, it may indicate that the user terminal 100 and at least one server within the server system 200 are communicating with each other.

The server system 200, in providing a voting service, may manage traffics occurring during communication with the user terminal 100, allocate resources to efficiently process the traffics, collect and store information submitted by the user terminal 100 in a database, and control the user terminal so that information processed may be provided to a user via an output device of the user terminal 100.

The user terminal 100 may communicate with the server system 200 through a network connected, or communicate with another external device. Here, the network may include a local area network (LAN), a wide area network (WAN), a value-added network (VAN), a mobile radio communication network, a satellite communication network, or a combination thereof. A network is a data communication network with a comprehensive meaning that enables each element entity shown in FIG. 1 to communicate with one another uninterruptedly, and may include wired Internet, wireless Internet, and a mobile wireless communication network. Wireless communication techniques used in a network may include, but are not limited to, a wireless LAN (wireless fidelity, Wi-Fi), Bluetooth, Bluetooth low energy (BLE), ZigBee, Wi-Fi direct (WFD), ultra-wideband (UWB), infrared data association (IrDA), near field communication (NFC), and so forth.

However, according to an example embodiment, the user terminal 100 or the server system 200 may include at least one processor and a memory configured to store at least one instruction executable by the processor. According to an example embodiment, the user terminal 100 may be connected to the server system 200 via a transceiver or a communication interface and exchange data, and the server system 200 may also be connected to the user terminal 100 via a transceiver or a communication interface.

The processor may perform at least one method described below with reference to FIGS. 1-3, 4A, 4B, 4C, 4D, 4E, 4F, 4G, and 5-11, and the memory may store information to execute at least one method described below with reference to FIGS. 1-3, 4A, 4B, 4C, 4D, 4E, 4F, 4G, and 5-11. The memory may be a volatile memory or a non-volatile memory. In addition, the processor of the user terminal 100 may control the user terminal 100 to execute a program and provide information, and the processor of the server system 200 may also control the server system 200 to execute a program and provide information. Additionally, program code executed by each processor may be stored in the memory.

Upon execution of an instruction stored in the memory, the processor of the user terminal 100 may be configured to receive a request related to a page from a user, and, process, when the request received is a request related to a first type page, the request related to the first type page (a page provided while a voting service category is active) by communicating with a content delivery network (CDN).

Meanwhile, upon execution of an instruction stored in the memory, the processor of the server system 200 may be configured to receive a request related to the first type page (a page provided while a voting service category is active) from a plurality of user terminals, select at least a portion of the requests in an order in which the requests are received, and process the selected requests by allocating a resource to the selected requests.

In describing with reference to FIG. 1, the user terminal 100 and the server system 200 are assumed to include only elements related to the example embodiment. However, other general-purpose elements may also be included in the user terminal 100 and the server system 200 according to the example embodiment, which will be understood by those skilled in the art to which the present embodiment relates.

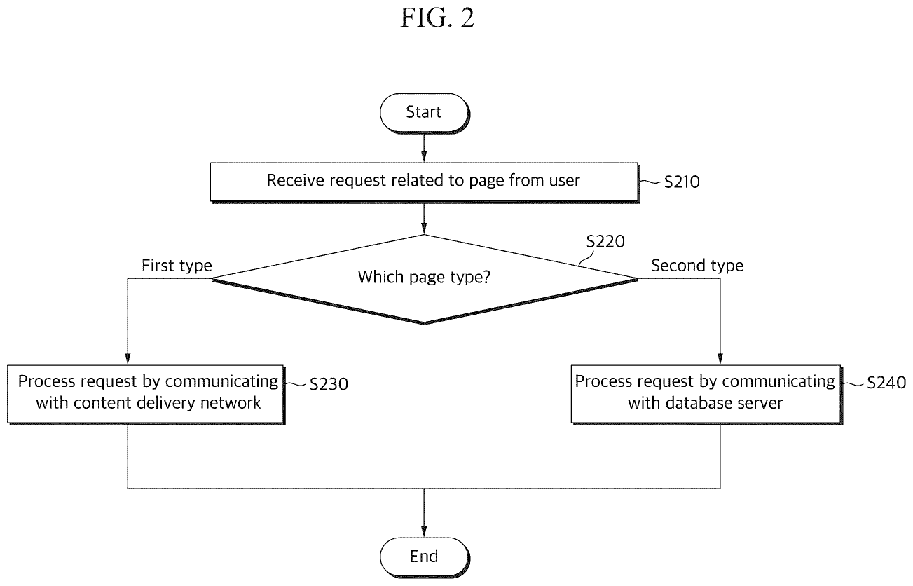

FIG. 2 is a flowchart illustrating a method of providing a voting service through the user terminal 100.

As illustrated, the user terminal 100 may receive a request related to a page from a user in operation S210. The user terminal 100 may identify which type of page the received request is related to in operation S220, and, when the request is related to a first type page-a page provided while a voting service category is active-, may process the request related to the first type page by communicating with a content delivery network (CDN) 210 in operation S230, and, when the request is related to a second type page-a page other than the first type page-, may process the request related to the second type page by communicating with a database server 220 in operation S240.

In other words, the user terminal 100 may distinguish between pages for which a request is made, process a request related to the first type page by communicating with the CDN 210 and process a request related to the second type page by communicating with the database server 220. This is because excessive short-term traffic may occur on a particular type of page, and, when a request is processed through the database server 220, high costs may be incurred as a number of database servers are required to process large-scale traffic. Additionally, when an infrastructure becomes complex due to multiple database servers, the burden of managing the infrastructure may increase. On the other hand, the CDN 210 may be able to handle more traffic than a database server, thereby enabling the management of a relatively smaller number of database servers. However, the method of using the database server 220 not only has drawbacks but also shows strength in some aspects, such as search engine optimization (SEO).

Accordingly, the user terminal 100 may use the CDN 210 for a request related to the first type page, considering a characteristic of having large-scale traffic during voting time, and may use the database server 220 to process a request related to the second type page, as there is a low probability of sudden traffic surge.

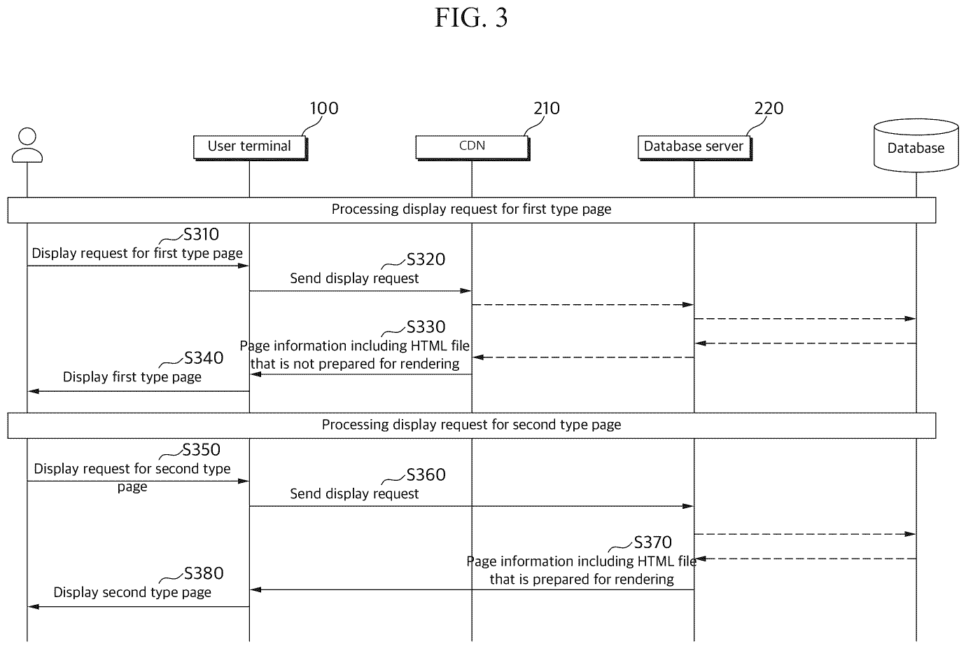

FIG. 3 is a flowchart for describing a method of processing a display request for a first type page and a second type page in greater detail.

Operations S310 to S340 relate to a method of processing a display request for the first type page, and operations S350 to S380 relate to a method of processing a display request for the second type page.

In relation to the first type page, the user terminal 100 may receive a display request for the first type page in operation S310 and may transmit the received display request to the CDN in operation S320. Then, as a response to the transmitted display request, the user terminal 100 may receive page information including a hypertext markup language (HTML) file that is not prepared for rendering from any CDN server included in the CDN in operation S330. Then, in operation S340, the user terminal 100 may display the first type page on a screen of the user terminal 100 based on the page information received.

More specifically, the user terminal 100 may receive a link to a HTML file that is not prepared for rendering and a JavaScript file from the CDN server, download the HTML file and the JavaScript file, and call an application programming interface (API) for data reception by executing the JavaScript file. Then, as the CDN server responds to a request from the API, the user terminal 100 may incorporate data received through the API into a placeholder property of the HTML file and display an interactive page to the user terminal 100.

Meanwhile, in relation to the second type page, the user terminal 100 may receive a display request for the second type page in operation S340, and may transmit the received display request to the database server 220 in operation S360. Then, as a response to the transmitted display request, the user terminal 100 may receive page information including a HTML file that is prepared for rendering from the database server 220 in operation S370. Then, in operation S380, the user terminal 100 may display the second type page on a screen of the user terminal 100 based on the page information received.

More specifically, the database server 220 may forward the HTML file that is prepared for rendering to the user terminal 100. Rendering of the HTML file may commence immediately after the HTML file is forwarded to the user terminal 100, and accordingly, a user may be enabled to view contents of the second type page even while the user terminal 100 is downloading the JavaScript file. Then, when the JavaScript file is successfully compiled in the user terminal 100, the second type page may be displayed in an interactive state. While such a method is advantageous for purposes such as SEO, because the server is tasked with rendering preparation, more server resource is required, thereby making it less ideal for managing sudden traffic surges or large-scale traffic. For this reason, maximum efficiency may be achieved by combining the described method with the method of using the CDN server.

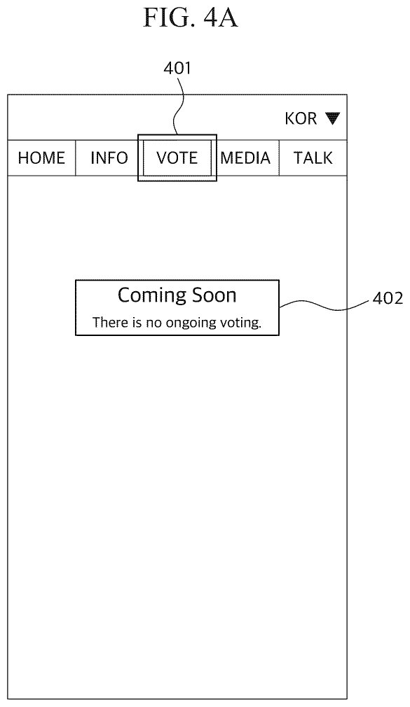

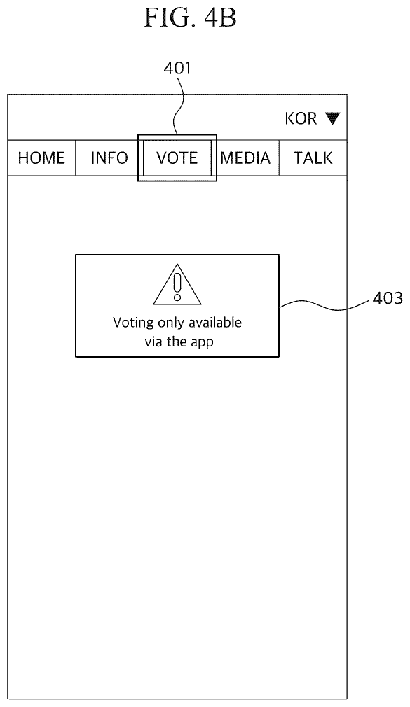

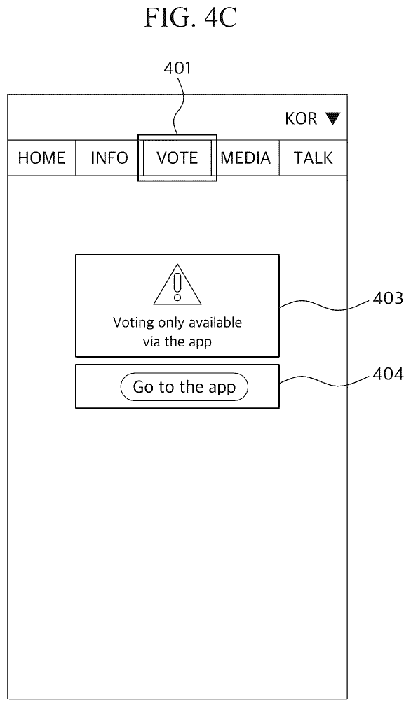

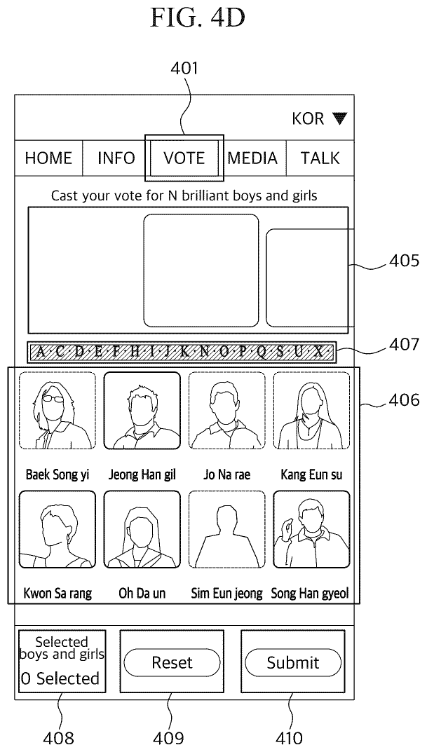

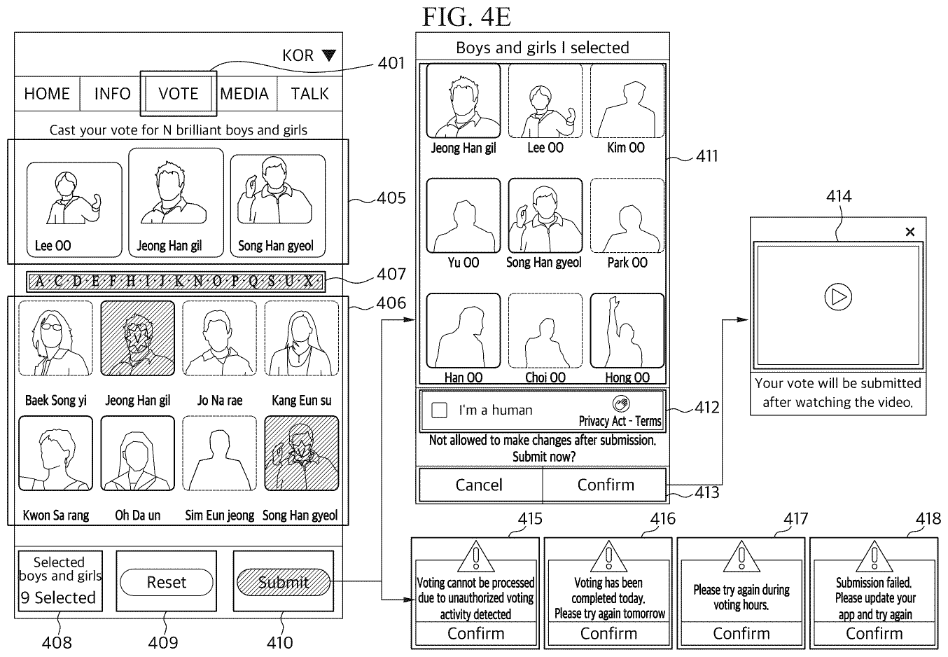

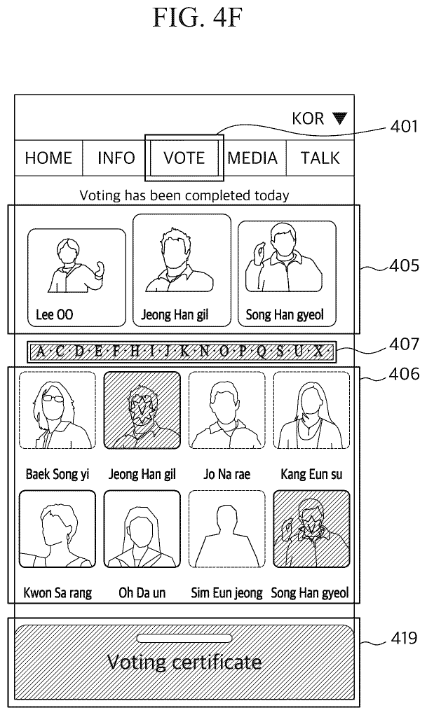

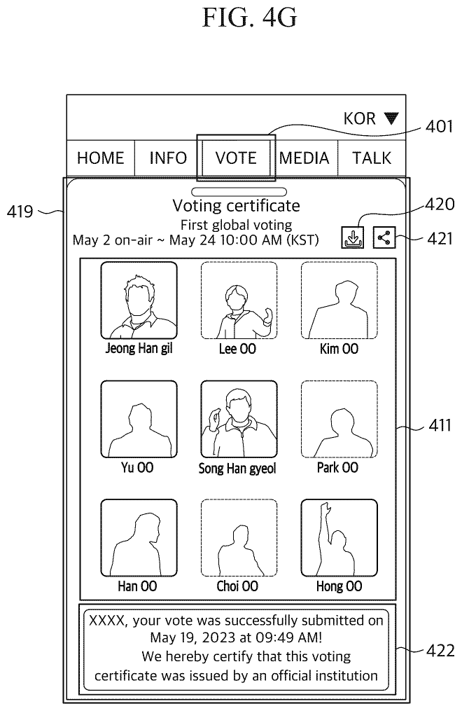

Meanwhile, in the present disclosure, the ‘first type page’ may collectively refer to a page that is provided by a voting service accessible via an application or a web page through the user terminal 100, while a voting service category is active. According to an example embodiment, the first type page may include 1) a selection page for selecting at least one of a plurality of options and 2) a voting complete page displaying voting results after voting information for selected option is submitted. In an additional example embodiment, the first type page may also include 3) a post-selection page configured to request user confirmation prior to submitting the voting information, or to notify a user of the voting information's eligibility for submission. Similarly, various types of the first type page related to voting may exist, and a representative example embodiment incorporating the above 1), 2), and 3) will be described below with reference to FIGS. 4A, 4B, 4C, 4D, 4E, 4F, and 4G.

FIGS. 4A, 4B, 4C, 4D, 4E, 4F, and 4G are illustrative diagrams of a voting service screen provided through a user terminal. For explanatory convenience, it is assumed that FIGS. 4A, 4B, 4C, 4D, 4E, 4F, and 4G illustrate page screens related to an audition program for selecting K-pop group members to debut through voting. Contents for each page may be categorized into a plurality of tabs as shown on the top of FIGS. 4A, 4B, 4C, 4D, 4E, 4F, and 4G, and HOME tab may display a main page of the website providing an overview of various contents, INFO tab may display a profile page of a cast member of the audition program, and MEDIA tab may display video clips and promotional videos, for example, of the audition program. In addition, TALK tab may display a fan community service page (e.g., a chat room, and a visitor's book) for multiple viewers (users) to take part in. Meanwhile, VOTE tab 401, which is a voting service category, when a user selects the VOTE tab 401, the first type page related to the voting service of the audition program may be displayed. When only the VOTE tab 401 is considered as the voting service category, the pages displayed when a user selects the HOME, INFO, MEDIA, and TALK tabs may correspond to the second type page.

First, FIGS. 4A, 4B, and 4C illustrate a case in which the first type page related to voting of the audition program is not displayed. Individually, FIG. 4A illustrates a page displaying a notification 402 indicating that there is no currently ongoing voting, FIG. 4B illustrates a page displaying a notification 403 indicating that voting is available via an application (app) when accessed to the website using a PC, and FIG. 4C illustrates a page displaying a notification 403 indicating that voting is available via an app when accessed to the website from a mobile environment (e.g., a tablet, a smartphone, etc.), and a link to the app 404. Here, the link to the app 404 may vary depending on whether the app is installed on the user terminal 100. For example, when the app is already installed, the link may direct to a page related to the voting service within the launched app, and, when the app is not installed, the link may direct to a page for downloading the app.

Meanwhile, FIGS. 4D, 4E, 4F, and 4G illustrate a case in which the first type page related to voting of the audition program is properly displayed. More specifically, FIG. 4D is an example of the selection page for selecting at least one of multiple candidate members, FIG. 4E is an example of the post-selection page displayed prior to a submission of voting information, and FIGS. 4F and 4G are examples of the voting complete page displaying voting results after voting information is submitted.

As illustrated in FIG. 4D, the selection page may display a frame object 405 corresponding to a number of selectable options, and an image 406 for each of a plurality of options. Additionally, an image of an option selected among the plurality of options may be displayed within the frame object 405. Furthermore, a name for each of the plurality of options may be displayed on the selection page, and each option may be arranged and displayed based on the name. An alphabet bar interface 407 positioned between sections 405 and 407 is for assisting a user to easily search for an option, and may provide a function that displays options with names starting with a selected alphabet when a user selects the alphabet. Accordingly, the name of each option may be written in Korean, English, or in a third language, and the options may be arranged based on the first letters of a Korean surname or an English last name.

Meanwhile, different graphic effects may be applied to a square frame that displays the image 406 of the plurality of options, based on a characteristic an option. For example, for the image 406, frames of four out of eight candidate members (Jeong Han gil, Kwon Sa rang, Oh Da un, and Song Han gyeol) are displayed with bold lines, while frames of the other four (Baek Song yi, Jo Na rae, Kang Eun su, and Sim Eun jeong) are displayed with dotted lines. Such graphic effects may be applied based on various characteristics of each candidate member, such as, agency, training period, gender, rate of votes earned, number of votes earned, team, and age. Additionally, an interface 408 showing the number of selected option(s), an interface 409 for initializing the selected option(s), and an interface 410 for submitting voting information for the selected option(s) are illustrated at the bottom of FIG. 4D.

FIG. 4E illustrates an example of the post-selection page, which is switched into when a user selects interface 410 after selecting an option. As illustrated in the left portion of FIG. 4E, when a user selects the interface 410 after selecting nine people (nine options) including Jeong Han gil and Song Han gyeol, either the post-selection page requesting user confirmation to submit the voting information or other various post-selection pages notifying that the voting information is not eligible to be submitted may be displayed, depending on whether the current voting information is eligible for submission. For example, when the voting information is eligible for submission, a post-selection page including an option selected 411 in the selection page, a human interaction proof (HIP) interface 412, and a confirmation button 413 may be displayed.

According to an example embodiment, while the submission of voting information may be completed depending on a user's input for the confirmation button 413 after passing HIP, a video advertisement 414 may be played automatically, and, in this case, the post-selection page may be switched into the voting complete page once the video advertisement is finished playing. Thus, by incorporating video advertisement 414 and inducing users to watch the video advertisement to cast their votes, the profitability of a program involving voting may be increased through advertising revenue.

Meanwhile, notification pages 415 to 418 illustrated at the bottom of FIG. 4E are various types of pages indicating that the voting information is not eligible for submission, each page displaying the reason for the inability to submit the voting information. In sequential order, a notification page 415 displayed when a fraudulent act (an abuse) related to a vote casted by a user occurs or a user attempting to cast a vote is on a blacklist, a notification page 416 displayed when multiple voting is attempted using the same device, a notification page 417 displayed when voting has been attempted outside the voting period, and a notification page 418 displayed when a unique device value (e.g., SSAID) is absent or when communication between the application and the server is abnormal are illustrated as an example. With regard to the notification page 417, a reference point for determining whether a given time falls within a voting period may be configured in various ways, and even if the selection page or the post-selection page is accessed within an active voting period, the page 417 may still be provided when the voting period has ended at the time of submitting voting information or after viewing the video advertisement 414.

Meanwhile, FIGS. 4F and 4G illustrate an example of the voting complete page displaying voting results after submitting a selected option. FIG. 4F illustrates an example of the voting complete page wherein a voting certificate 419 provided in a bottom sheet form is folded, and FIG. 4G illustrates an example of a voting complete page with the voting certificate 419 unfolded. In a state in which the voting certificate 419 is folded, the options selected by a user (including Jeong Han gil, and Song Han gyeol) are displayed through the frame object 405, however, in a state in which the voting certificate 419 is unfolded, the options selected by a user may be displayed in a grid format within the voting certificate. Additionally, a stamp 422 confirming the validity of the voting certificate may be displayed at the bottom of the voting certificate 419, and the stamp 422 may display a user's display name, voting date and time, and a name of an organization confirming the validity of the voting certificate, and so forth. However, whether the stamp 422 is displayed and types of information included in the stamp 422 may be configured in various ways according to an example embodiment. The voting certificate 419 may be utilized as a medium to certify participation in a fan community among users watching a program that involves voting, and to encourage others to participate in the fan community. For this purpose, a graphic object 420 that provides a function to download the voting certificate 419 in an image form, or a graphic object 421 that provides a function to share the voting certificate 419 to a social network service (SNS) may be displayed on the voting certificate 419.

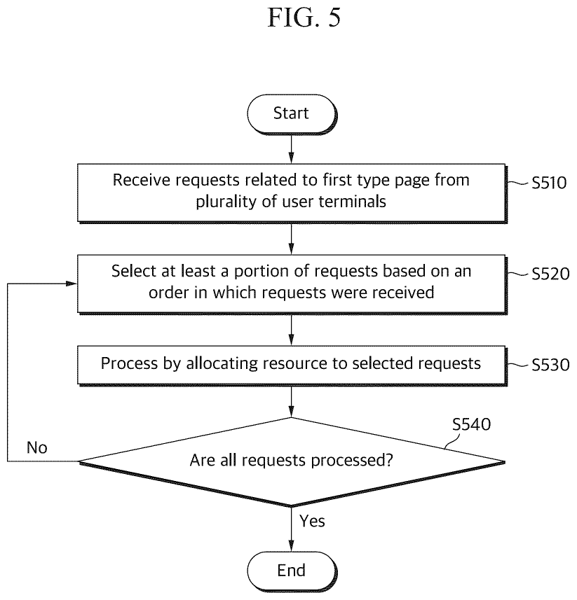

FIG. 5 is a flowchart illustrating a method of providing a voting service through the server system 200.

As illustrated, the server system 200 may receive requests related to the first type page-a page provided while a voting service category is active-from a plurality of user terminals in operation S510. Then, in operation S520, the server system 200 may select at least a portion of the requests based on an order in which the requests are received, and may process the selected requests by allocating resources to the selected requests in operation S530. In operation S520, the server system 200 may newly select at least a portion of requests remaining after excluding the selected requests based on an order in which the request are received every time each of the selected requests is processed.

According to an example embodiment, the server system 200 may select a predetermined number of requests in an order in which the requests are received, while any remaining, unselected requests may be managed in a queue. This management method may be particularly useful for processing sudden traffic surges, such as those encountered when managing voting in an audition program. This is because, in a serverless environment, which is often used to reduce time and cost of building a server, or in an auto-scaling environment, in which the number of servers is changed automatically according to the number of users, a server may shut down at an initial stage of server heating due to sudden traffic surge, however, the management method enables prioritized processing of requests that fall within a range that avoids server shutdown and subsequent queuing of any remaining requests, thereby preventing server shutdown.

According to an example embodiment, the server system 200 may transmit a standby request to each of the user terminals that transmitted the requests remaining after excluding the selected requests while processing the selected requests. More specifically, the server system 200 may provide a standby request to each user terminal in the form of a push-notification, vibration, a popup window, or the like.

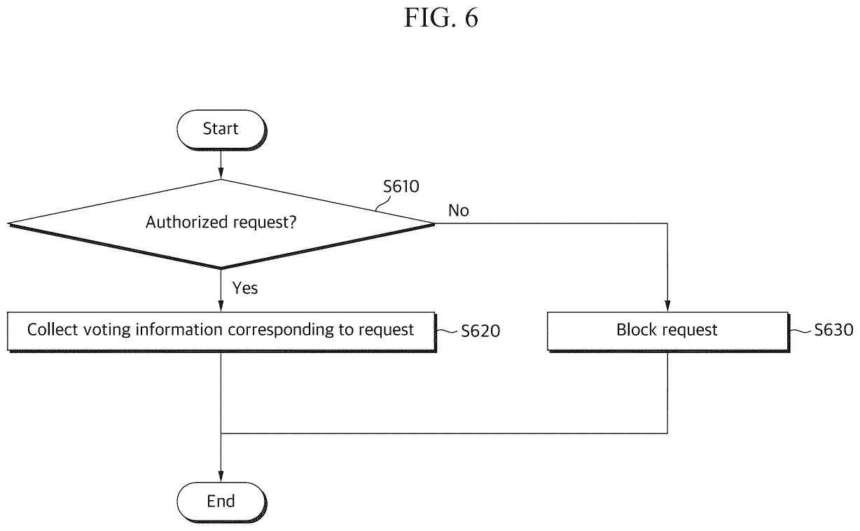

FIG. 6 is a flowchart for describing operation S530 in greater detail. More specifically, FIG. 6 illustrates an example of a process of processing a submission request for voting information transmitted from a user terminal, through the first type page.

As illustrated, the server system 200 may determine whether to authorize each of the selected requests in operation S610, may collect voting information corresponding to the authorized request among the selected requests in operation S620, and may block a request that is not authorized among the selected requests in operation S630.

In the present disclosure, any submission request for voting information that violates predetermined voting regulations may be collectively referred to as a fraudulent act (an abuse). In this aspect, the server system 200's determination of whether to authorize a request includes determining whether the request corresponds to an abuse. The voting regulations may be defined in various ways, however, typical examples may include the following:
1) Number of times: One vote per day/One vote within the voting period
2) Plural voting: Voting for N number of people per vote/Voting for up to N number of people per vote/Voting for one person per vote
3) Voting results: Total votes cast, votes cast per candidate, and rate of votes earned provided/Total votes cast and votes cast per candidate provided/Only total votes cast provided/Undisclosed
4) Voting scenario flow: Introduction page for voting regulations—Candidate selection—Submission—HIP—Video advertisement—Final submission

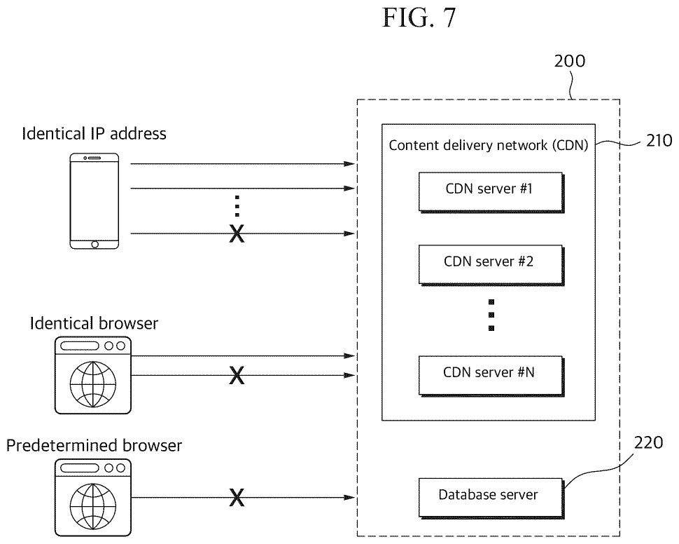

In the interest of consumers, ensuring the fairness of voting is essential to encourage active user (participant) participation, to establish the service's reliability, as well as to enhance popularity and profitability. For this reason, it is crucial to authorize or block each request by sorting out abuses through operation S610, and various methods for sorting out abuses more precisely and meticulously will be proposed with reference to FIGS. 7 to 10 below. Each method may be applied individually, or two or more methods may be combined for application.

FIGS. 7 to 10 are illustrative diagrams related to an example embodiment for sorting out an abuse among user requests.

Referring to FIG. 7, the server system 200 may determine and block a request as an unauthorized request when the request is transmitted more than a predetermined number of times from a user terminal assigned with an identical internet protocol (IP) address. That is, when a request is transmitted over a predetermined time from a user terminal assigned with the same IP address, the server system 200 may determine this act as multiple voting, which constitutes a violation of the voting regulations.

In addition, the server system 200 may determine and block a request as an unauthorized request when the request is transmitted multiple times from a browser with identical browser identification information. That is, even if a different user terminal is used, when a request identical to one submitted previously is submitted through the same browser by logging in with the same ID, the server system 200 may determine this act as multiple voting, which constitutes a violation of the voting regulations.

Additionally, the server system 200 may determine and block a request as an unauthorized request when the request is transmitted through a browser with particular browser identification information. For example, some browsers readily connect to proxy servers and support various add-on functions, such as changing an IP address by connecting to virtual private network (VPN). For this reason, the server system 200 may determine a request transmitted from such browsers as an invalid vote, which constitutes a violation of voting regulations, to prevent issues arising from the use of such browsers.

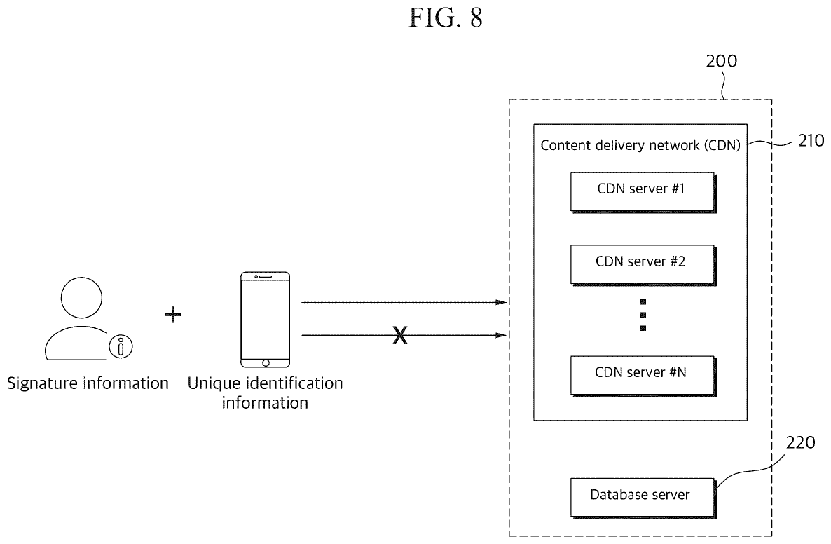

Referring to FIG. 8, the server system 200 may identify a combination of 1) signature information to authenticate a voting service application installed on each user terminal which transmitted the selected requests and 2) unique identification information of each of the user terminals which transmitted the selected requests, and determine and block a request transmitted from a user terminal which the combination is identified more than once as an unauthorized request.

For example, the signature information of 1) may include an encryption key, a decryption key, a personal identification number (PIN), an electronic signature, iris recognition information, facial recognition information, fingerprint information, for example, and the unique identification information of 2_ may include, for example, international mobile equipment identity, service set identifier (SSID, a wireless router network name), or universally unique identifier. Since the combination of 1) and 2) will be unique for each user terminal, the server system 200 may use the combination as a reference to determine a user terminal which the combination is identified more than once.

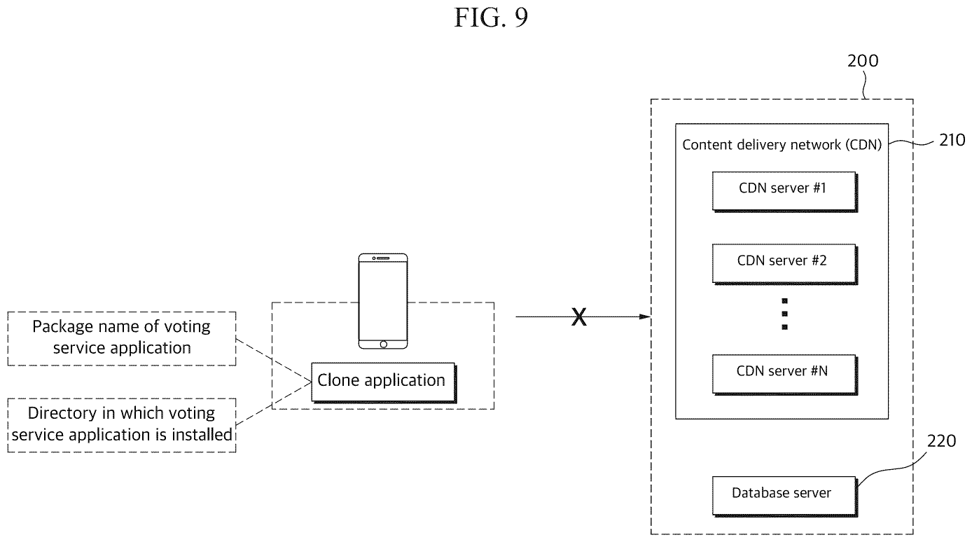

Meanwhile, FIG. 9 illustrates an example embodiment for preventing voting abuse that is relatively effective in a mobile environment. Referring to FIG. 9, the server system 200 may determine whether a clone application of a voting service application is installed for each user terminal based on a package name and an installation directory of the voting service application installed on each user terminal that transmitted the selected requests, and block a request transmitted from a user terminal determined to have the clone application installed as an unauthorized request.

More specifically, clone applications may enable the use of multiple accounts without requiring manipulations, such as logging in/logging out, and there are concerns that such applications may be exploited for voting abuse, including multiple voting. Accordingly, determining whether a clone application is installed is crucial in preventing voting abuse, and the server system 200 may use the package name and installation path (installation directory) as identifying features of a clone application. For example, a package name of a clone application is often generated by adding or modifying a portion of a package name of an original application (a voting service application), and a directory in which a clone application is installed is typically different from a directory in which an original application is installed. For these reasons, the server system 200 may be capable of determining whether a clone application is installed based thereon.

According to an example embodiment, the server system 200 may determine a request as an authorized request even if the request is transmitted from a user terminal determined to have a clone application installed, provided that the request is transmitted from an original application installed on the user terminal. That is, a request transmitted from a user terminal with a clone application installed is not unquestioningly blocked but instead further investigated to identify whether the source of the request is the original application or the clone application, thereby increasing accuracy of abuse identification. However, in this case, a request transmitted from a user terminal 100 may be required to include voting information that includes information that enables identification of an application through which the request was made. A service provider or a developer may make this decision by considering accuracy of abuse identification, the volume of information transmitted and received, and corresponding resource consumption.

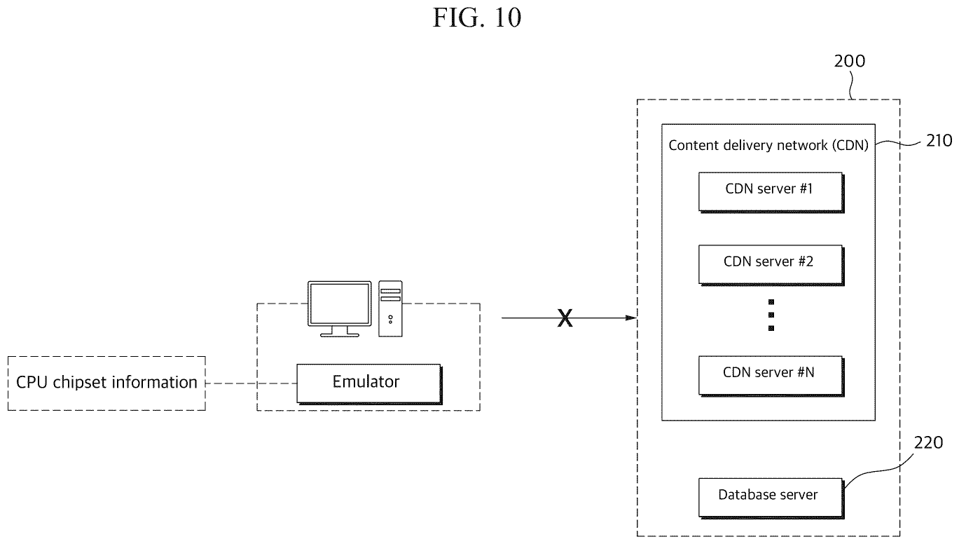

Meanwhile, FIG. 10 illustrates an example embodiment for preventing voting abuse which is relatively effective in a PC environment. Referring to FIG. 10, the server system 200 may determine whether an emulator of a voting service application is installed on each user terminal based on chipset information of central processing unit (CPU) of each user terminal that transmitted the selected requests, and block a request transmitted from a user terminal determined to have the emulator installed as an unauthorized request.

Given that an emulator may also be exploited for voting abuse by virtually launching a voting service application, identifying and determining whether an emulator is installed is as important for preventing voting abuse as identifying and determining a clone application.

However, similar to FIG. 9, the server system 200 may determine a request as an authorized request even if the request is transmitted from a user terminal that is determined to have an emulator installed, provided that the request is transmitted from an original application installed on the user terminal, but may determine the request as an unauthorized request when the request is transmitted through the emulator. That is, a request transmitted from a user terminal with an emulator installed is not unquestioningly blocked but instead further investigated to identify whether the source of the request is the original application or the emulator, thereby increasing accuracy of abuse identification. However, in this case, a request transmitted from a user terminal 100 may be required to include voting information that includes information that enables to identify whether the request was made from an original application or an emulator. A service provider or a developer may decide in consideration of accuracy of abuse identification and amount of information being transmitted and received, as well as resources consumed accordingly.

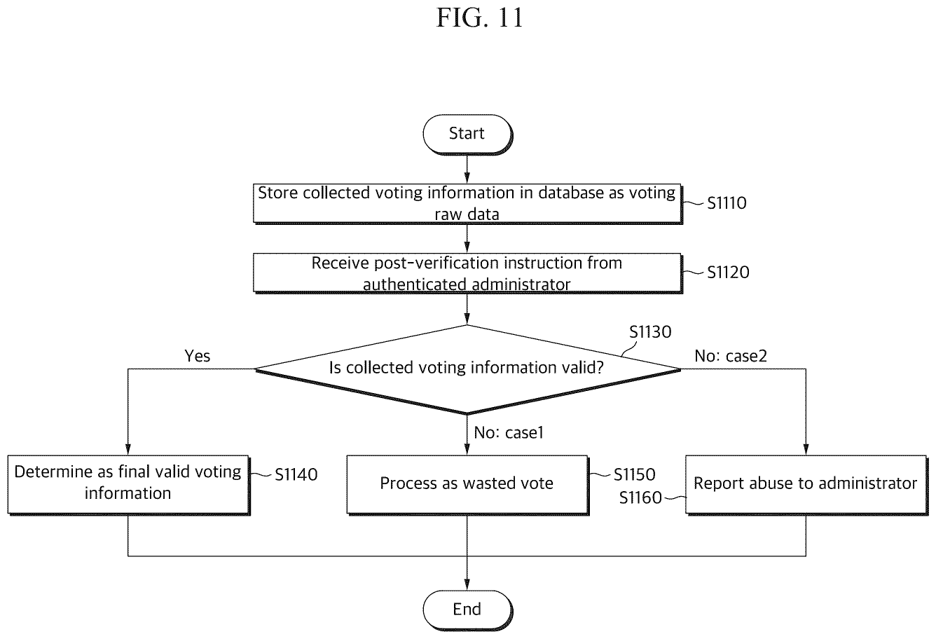

FIG. 11 is a flowchart of an example embodiment for post-verifying collected voting information.

As illustrated with reference to FIG. 5, the server system 200 may receive requests related to the first type page—a page provided while a voting service category is active-from a plurality of user terminals in operation S510. Then, the server system 200 may select at least a portion of the requests based on an order in which the requests are received in operation S520, and process the selected requests by allocating a resource to the selected requests in operation S530. In particular, as illustrated in FIG. 6, the server system 200, in processing a submission request made through the first type page, may collect voting information by authorizing a portion of the submission requests, while not authorizing and blocking others, as representatively exemplified in FIGS. 7 to 10. However, even voting information that has already been collected may still present a potential for validity misjudgment during a collection process, or for having factors that were overlooked initially. In recent years, there have been attempts to manipulate voting and impair fairness using various voting abuse schemes, thereby necessitating a thorough post-verification on collected voting information.

Accordingly, the server system 200 may store the collected voting information as voting raw data in a database according to a predetermined schema in operation S1110. Then, the server system 200 may receive a post-verification instruction from an administrator authorized using signature information in operation S1120, and may determine validity of each piece of collected voting information based on the voting raw data in operation S1130 according to the post-verification instruction. As a result, the server system 200 may determine voting information determined as valid as final valid voting information in operation S1140.

According to an example embodiment, the voting raw data stored in the database by the server system 200 may include at least one of voting date, user identification information, user terminal identification information (which may be classified by operating system or manufacturer), browser identification information, email address, user name, user display name, and the time the voting raw data was input into the database. When at least a portion of information included in the voting raw data overlaps, or when an error occurs, such as not falling within a voting period, the server system 200 may determine the voting information corresponding to the voting raw data as invalid.

Meanwhile, according to an example embodiment, the server system 200 may process the voting information determined as invalid in operation S1130 as a wasted vote based on a reason of the determination (case1), or report the voting information as a potential abuse to an administrator, without making an autonomous judgement (case2).

As an example for case1, the server system 200 may autonomously process and block voting information collected from a user terminal using a temporary email address as a wasted vote. For example, the server system 200 may identify, among pieces of voting raw data stored in the database as collected voting information, voting raw data in which an email address included in the voting raw data is a temporary email address, and determine and block voting information corresponding to the identified voting raw data as invalid voting information.

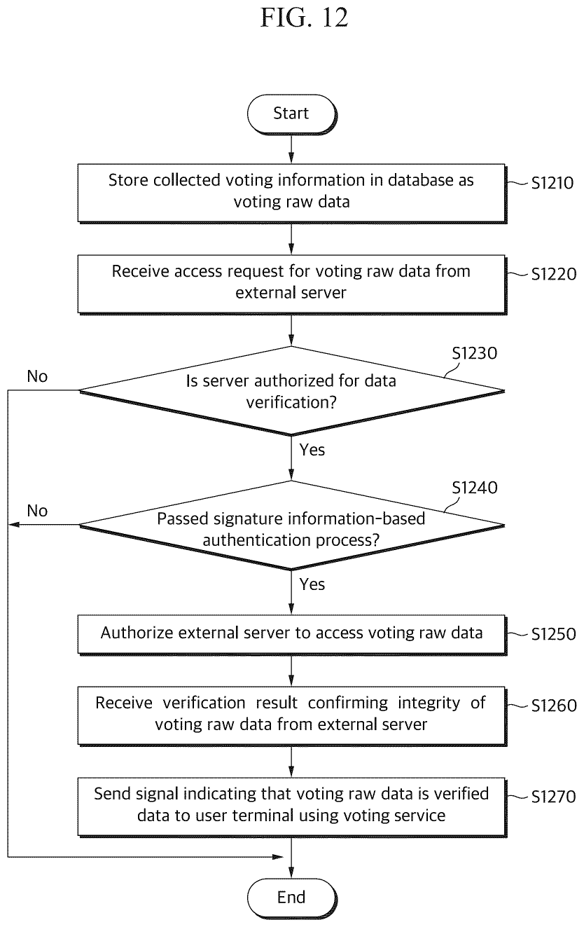

FIG. 12 is a flowchart of an example embodiment for verifying collected voting information by an external server. While performing autonomous post-verification on voting information using the server system 200 as shown in FIG. 11 may be effective for enhancing fairness and reliability of voting, verification by a specialized external organization may further build trust among the public using the voting service.

Accordingly, the server system 200 may store the collected voting information as voting raw data in a database according to a predetermined schema in operation S1210. Then, the server system 200 may receive a request to access the voting raw data from an external server in operation S1220. Accordingly, the server system 200 may determine whether the external server is authorized to verify data in operation S1230, and may determine when the external server passed a predetermined signature information-based authentication process in operation S1240. The signature information-based authentication process (logic) for determining whether to authorize to access the voting raw data may be configured in various ways.

when the external server is not authorized to perform verification of data, or fails the signature information-based authentication process, the server system 200 may block the external server from accessing the voting raw data. Alternatively, when the external server is authorized to verify data, and passed the signature information-based process, the server system 200 may authorize the external server to access the voting raw data in operation S1250. According to an example embodiment, the server system 200 may provide the voting raw data in an application programing interface (API) format to the external server.

Then, the server system 200 may receive a verification result confirming integrity of the voting raw data from the external server in operation S1260. Then, the server system 200 may transmit a signal indicating that the voting raw data is verified data to a user terminal using the voting service in operation S1270. According to an example embodiment, the signal transmitted by the server system 200 may be displayed in various formats such a message, a popup window, a push-notification, a stamp, or a graphic object through a voting service application installed on the user terminal, allowing the user to perceive that the voting raw data has been verified.

The device in accordance with the example embodiments described above may include a processor, a memory that stores and executes program data, a permanent storage such as a disk drive, a communication port for communicating with an external device, and a user interface device such as a touch panel, a key, and a button. Methods realized by software modules or algorithms may be stored in a computer-readable recording medium as computer-readable codes or program commands which may be executed by the processor. Here, the computer-readable recording medium may be a magnetic storage (such as a read-only memory (ROM), a random-access memory (RAM), a floppy disk, and a hard disk), an optical storage (such as a CD-ROM, and a digital versatile disc (DVD)), and the like. The computer-readable recording medium may be dispersed across computer systems connected by a network, allowing computer-readable code to be stored and executed in a distributed manner. The medium may be read by a computer, stored in memory, and executed by the processor.

The example embodiments may be represented by functional blocks and various processing steps. These functional blocks may be implemented by various numbers of hardware and/or software configurations that execute specific functions. For example, the example embodiments may adopt direct circuit configurations such as a memory, a processor, a logic circuit, and a look-up table that may execute various functions by control of one or more microprocessors or other control devices. Similarly to that elements may be executed by software programming or software elements, the example embodiments may be implemented by programming or scripting languages such as C, C++, Java, and assembler including various algorithms implemented by combinations of data structures, processes, routines, or of other programming configurations. Functional aspects may be implemented by algorithms executed by one or more processors. In addition, the example embodiments may adopt the related art for electronic environment setting, signal processing, and/or data processing, for example. The terms “mechanism”, “element”, “means”, and “configuration” may be widely used and are not limited to mechanical and physical components. These terms may include meaning of a series of routines of software in association with a processor, for example.

The example embodiments described above are for illustrative purposes only and other embodiments may be implemented within the scope of the following claims.

1. A method of providing a voting service through a user terminal, the method comprising:
receiving a request related to a page from a user;
processing, when the request is a request related to a first type page, the request related to the first type page by communicating with a content delivery network (CDN); and
processing, when the request is a request related to a second type page, the request related to the second type page by communicating with a database server,
wherein the first type page is a page provided while a voting service category is active, and
the second type page is a page other than the first type page.

2. The method of claim 1, wherein the processing of the request related to the first type page comprises processing a display request for the first type page, and
the processing of the display request for the first type page comprises:
transmitting the display request to the CDN;
receiving page information comprising a hypertext markup language (HTML) file that is not prepared for rendering from any CDN server included in the CDN; and
displaying the first type page on a screen of the user terminal based on the page information.

3. The method of claim 1, wherein the processing of the request related to the second type page comprises processing a connection request for the second type page, and
the processing of the display request for the second type page comprises:
transmitting the display request to the database server;
receiving page information comprising an HTML file that is prepared for rendering from the database server; and
displaying the second type page on a screen of the user terminal based on the page information.

4. The method of claim 1, wherein the first type page includes:
a selection page from which at least one of a plurality of options is selectable; and
a voting complete page that displays voting results after submitting voting information based on the option selected from the selection page.

5. The method of claim 4, wherein, from the selection page, an image for each of the plurality of options and a frame object corresponding to a selectable number of options are displayed, and
an image of an option selected from the plurality of options is displayed within the frame object.

6. The method of claim 4, wherein, from the selection page, a name for each of the plurality of options is displayed, and
the plurality of options are arranged and displayed based on the name.

7. The method of claim 4, wherein the first type page further comprises a post-selection page that requests a user to confirm whether to submit the voting information or that notifies whether the voting information is eligible for submission, prior to submission of the voting information.

8. The method of claim 7, wherein, from the post-selection page, a submit button for submitting the voting information is displayed, and
upon selection of the submit button, a selected option, a human interaction proof (HIP) interface, and a confirmation button are displayed,
upon selection of the confirmation button after passing HIP, a video advertisement is played automatically, and
when the video advertisement is finished playing, the page is switched to the voting complete page.

9. A method of providing a voting service through a server system including a content delivery network (CDN) server and a database server, the method comprising:
receiving requests related to a first type page from a plurality of user terminals;
selecting at least a portion of the requests based on an order in which the requests are received; and
processing the selected requests by allocating a resource to the selected requests,
wherein the first type page is a page provided while a voting service category is active, and
the selecting includes newly selecting at least a portion of requests remaining after excluding the selected requests based on an order in which the requests are received every time each of the selected requests is processed.

10. The method of claim 9, further comprising transmitting a standby request to each user terminal that has transmitted the requests remaining after excluding the selected requests while the selected requests are being processed.

11. The method of claim 9, wherein, in processing a submission request for voting information through the first type page, the processing comprises:
determining whether to authorize each of the selected requests;
collecting voting information corresponding to an authorized request among the selected requests; and
blocking an unauthorized request among the selected requests.

12. The method of claim 11, wherein the determining of whether to authorize each of the selected requests comprises determining, a request transmitted more than a predetermined number of times from a user terminal to which an identical internet protocol (IP) address is assigned, a request transmitted for more than once through a browser with identical browser identification information, or a request transmitted through a browser corresponding to predetermined browser identification information, as an unauthorized request.

13. The method of claim 11, wherein the determining of whether to authorize each of the selected requests comprises:
identifying a combination of signature information for authenticating a voting service application installed on each of user terminals that transmitted the selected requests, and unique identification information of each of the user terminals; and
determining a request transmitted from a user terminal of which the combination is identified more than once as an unauthorized request.

14. The method of claim 11, wherein the determining of whether to authorize each of the selected requests comprises:
determining, based on a package name and an installation directory of a voting service application installed on each of user terminals that transmitted the selected requests, whether a clone application of the voting service application is installed on each of the user terminals; and
determining a request transmitted from a user terminal determined to have the clone application installed as an unauthorized request.

15. The method of claim 11, wherein the determining of whether to authorize each of the selected requests comprises:
determining, based on chipset information of a central processing unit (CPU) of each of user terminals that transmitted the selected requests, whether an emulator for a voting service application is installed on each of the user terminals; and
determining a request transmitted from a user terminal determined to have the emulator installed as an unauthorized request.

16. The method of claim 11, further comprising:
storing the collected voting information in a database as voting raw data according to a predetermined schema;
receiving a post-verification instruction from an administrator authorized using signature information;
determining validity of each piece of the collected voting information based on the voting raw data according to the post-verification instruction; and
determining voting information determined to be valid as final valid voting information.

17. The method of claim 16, wherein the determining of the validity of each piece of the collected voting information comprises:
identifying, among pieces of the voting raw data, voting raw data in which an email address included in the voting raw data is a temporary address; and
determining voting information corresponding to the identified voting raw data as invalid voting information.

18. The method of claim 11, further comprising:
storing the collected voting information in a database as voting raw data according to a predetermined schema;
authorizing an external server, that is authorized to verify data and had passed a predetermined signature information-based authentication process, to access the voting raw data; and
receiving a verification result confirming integrity of the voting raw data from the external server.

19. The method of claim 18, further comprising transmitting a signal indicating that the voting raw data is verified data to any user terminal using the voting service.

20. A user terminal providing a voting service, the user terminal comprising:
at least one processor; and
a memory configured to store at least one instruction executable by the at least one processor,
wherein the at least one processor is configured to, upon execution of the at least one instruction:
receive a request related to a page from a user;
process, when the request is related to a first type page, the request related to the first type page by communicating with a content delivery network (CDN), and
process, when the request is related to a second type page, the request related to the second type page by communicating with a database server,
wherein the first type page is a page provided while a voting service category is active, and
the second type page is a page other than the first type page.
